(19) United States
(12) Patent Application Publication
(10) Pub. No.: US 2006/0227356 A1
(43) Pub. Date: Oct. 12, 2006

(54) Print method to increase a lifetime of a printer head and printer, host, and print system using the same

(76) Inventors: Jin-wook Jeong, Yongin-si (KR); Young-bok Ju, Seongnam-si (KR)

Correspondence Address: STANZIONE & KIM, LLP, 919 18TH STREET, N.W., SUITE 440, WASHINGTON, DC, 20006, US

(21) Appl. No.: 11/317,072

(22) Filed: Dec. 27, 2005

(30) Foreign Application Priority Data
Apr. 12, 2005 (KR) 10-2005-0030435

(51) Int. Cl. G06F 3/12

(52) U.S. Cl. 358/1.13

(57) ABSTRACT

A print method to increase a lifetime of a printer head and a printer, a host, and a print system using the print method. The print method includes counting an amount of printing performed in a current print job, outputting a page inverting signal when the current print job is complete and the counted amount of printing performed is greater than a threshold value, and receiving and printing a page of a next print job that corresponds to the page inverting signal.

### CROSS-REFERENCE TO RELATED APPLICATIONS

This application claims the benefit of Korean Patent Application No. 2005-30435, filed on Apr. 12, 2005, in the Korean Intellectual Property Office, the disclosure of which is incorporated herein in its entirety by reference.

### BACKGROUND OF THE INVENTION

1. Field of the Invention

The present general inventive concept relates to a print method to increase a lifetime of a printer head and a printer, a host, and a print system using the print method, and more particularly to a print method using a line-array printer head and a printer, a host, and a print system using the print method.

2. Description of the Related Art

In thermal inkjet type line-array printer heads, an ejection rate (i.e., amounts of ejections) of nozzles which can guarantee print quality is limited by manufacturers.

However, in line-array heads (i.e., wide-array type ink jet heads), since a plurality of nozzles is fixed to correspond to a width of a page, utilization frequencies of the nozzles may vary according to print data. That is, the nozzles that correspond to margins of the page may be used less frequently. However, since a print job is generally started from a left side of text, a jet rate of the nozzles on the left is greater than that of the nozzles on the right. In other words, since text on the page typically begins on the left hand side of the page, the nozzles on the left get used more frequently than the nozzles on the right. In this case, a lifetime of the line array heads depends upon aging of the nozzles on the left, which have a relatively large ejection rate compared to the nozzles on the right.

### SUMMARY OF THE INVENTION

The present general inventive concept provides a print method to increase a lifetime of a printer head by alternately performing a print job of an original page and a print job of an inverted page in accordance with an amount of printing performed so as to allow all nozzles to uniformly eject ink when performing one or more print jobs using a line-array printer head, and a printer, a host, and a print system using the print method.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing a print method comprising counting an amount of printing performed in a current print job, outputting a page inverting signal when the current print job is complete and the counted amount of printing performed is greater than a threshold value, and receiving and printing a page of a next print job that corresponds to the page inverting signal.

The foregoing and/or other aspects of the present general inventive concept are also achieved by providing a method of printing, the method comprising printing a first one or more pages in a normal mode, and printing a second one or more pages in an inverted mode.

The foregoing and/or other aspects of the present general inventive concept are also achieved by providing a method of printing, the method comprising monitoring an amount of printing performed in one or more jobs of a print head having a plurality of nozzles, and controlling the print head to print in one of an inverted mode and a normal mode such that the nozzles at two ends of the print head have about a uniform ejection rate according to the monitored amount of printing performed.

The foregoing and/or other aspects of the present general inventive concept are also achieved by providing a method of printing, the method comprising inverting print data of one or more pages to be printed when a page inverting signal is received from a printer, and providing the inverted print data of the one or more pages to the printer when the page inverting signal is received therefrom.

The foregoing and/or other aspects of the present general inventive concept are also achieved by providing a printer to receive a page from a host and to print the received page, the printer comprising a control unit to count an amount of printing performed in a print job, to output a predetermined signal to the host when the counted amount of printing performed in the print job is greater than a threshold value, and to process and output a page received from the host in response to the predetermined signal, and a head unit to print the page output from the control unit.

The foregoing and/or other aspects of the present general inventive concept are also achieved by providing a printer, comprising a print head, and a control unit to control the print head to print a first one or more pages in a normal mode and to print a second one or more pages in an inverted mode.

The foregoing and/or other aspects of the present general inventive concept are also achieved by providing a printer, comprising a print head having a plurality of nozzles to perform one or more jobs, and a control unit to monitor an amount of printing performed in the one or more jobs and to control the print head to print in one of an inverted mode and a normal mode such that the nozzles at two ends of the print head have about a uniform ejection rate according to the monitored amount of printing performed.

The foregoing and/or other aspects of the present general inventive concept are also achieved by providing a host to output a page to be printed by a printer, the host comprising a storage unit to store the page, a signal receiving unit to receive a predetermined signal from the printer, a page inverting unit to output the page stored in the storage unit as is or to invert and output the page based on whether the predetermined signal is received, and a printer driver to convert the page output from the page inverting unit into data suitable for a print job of the printer and to output the converted page.

The foregoing and/or other aspects of the present general inventive concept are also achieved by providing a host device, comprising a page inverting unit to invert print data of one or more pages to be printed when a page inverting signal is received from a printer, and a printer driver to provide the inverted print data of the one or more pages to the printer when the page inverting signal is received therefrom.

The foregoing and/or other aspects of the present general inventive concept are also achieved by providing a print system comprising a host to output a page to be printed, and to invert and output the page to be printed when a predetermined signal is received, and a printer to count an amount of printing performed in a print job, to output the predetermined signal to the host when the counted amount of printing performed in the print job is greater than a threshold value upon completion of the print job, and to receive and print the page output from the host in response to the predetermined signal.

The foregoing and/or other aspects of the present general inventive concept are also achieved by providing a computer readable medium containing executable code to control a printer to operate in one or more of a normal page mode and an inverted page mode, the medium comprising executable code to determine an amount of printing that is performed during a first print job in a first mode of the normal page mode and the inverted page mode, executable code to determine whether the amount of printing that is performed during the first print job exceeds a predetermined threshold, executable code to switch between the normal page mode and the inverted page mode to a second mode and to control the printer to advance to a second print job or standby when the amount of printing that is performed during the first print job exceeds the predetermined threshold, and executable code to control the printer to continue in the first mode and to advance to the second print job or standby when the amount of printing performed does not exceed the predetermined threshold.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 illustrates a structure of a line-array head;

FIG. 2 is a block diagram illustrating a print system according to an embodiment of the present general inventive concept;

FIG. 3 illustrates an example of a page which is printed in a normal mode and a page which is printed in an inverted mode; and

FIG. 4 is a flowchart illustrating a print method according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

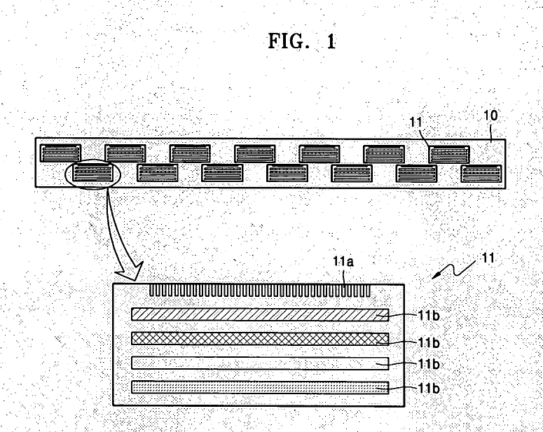

FIG. 1 illustrates a structure of a line-array head. The line-array head includes a head frame 10 and head chips 11. Each head chip 11 includes connection terminals 11 a and ink supply holes 11b to supply four colors of ink of cyan (C), magenta (M), yellow (Y), and black (B). Alternatively, the head chips 11 may have other arrangements to supply inks of other colors.

Although not shown, a nozzle plate having a plurality of nozzles is provided at an upper portion of the head frame 10 and several colors of ink are supplied to the ink supply holes 11b through the nozzles. The number of nozzles may be, for example, 1,200 dpi×8.5 inch (with reference to a printing sheet with A4 size)×four colors=40,800 when a print job is performed with a horizontal resolution of 1,200 dpi.

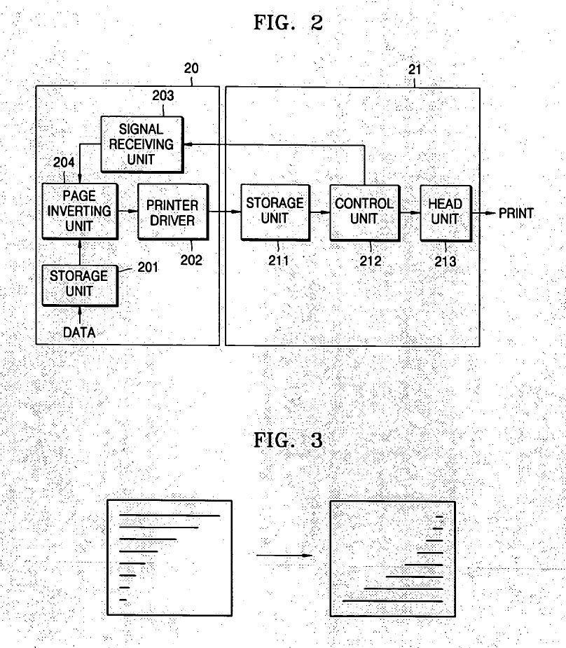

FIG. 2 is a block diagram illustrating a print system according to an embodiment of the present general inventive concept. The print system includes a host 20 and a printer 21.

The host 20 includes a storage unit 201, a printer driver 202, a signal receiving unit 203, and a page inverting unit 204.

First, a page to be printed is stored in the storage unit 201 in accordance with a print instruction through an application program. When receiving a page inverting signal from the signal receiving unit 203, the page inverting unit 204 inverts the page stored in the storage unit 201 and outputs the inverted page to the printer driver 202 to be printed in an inverted mode. When the page inverting unit 204 does not receive the page inverting signal from the signal receiving unit 203, the page inverting unit 204 outputs the page stored in the storage unit 201 to the printer driver 202, as is, to be printed in a normal mode. FIG. 3 illustrates an example of a page which is printed in the normal mode and a page which is printed in the inverted mode. The page that is printed in the inverted mode (on the right side of FIG. 3) is inverted by rotating a page to be printed 180° so as to have an opposite direction (orientation) of the page that is printed in the normal mode (on the left side of FIG. 3).

The signal receiving unit 203 receives the page inverting signal output from the printer 21 and outputs the received signal to the page inverting unit 204.

The printer driver 202 converts the page to be printed into page description language (PDL) data and outputs the converted page to the printer 21. The PDL data may be data in which an image is compressed in a JPEG (Joint Photographic Experts Group) format and a text is compressed in a JBIG (Joint Bi-level Image Experts Group) format.

The page inverting unit 204 inverts the page stored in the storage unit 201 in accordance with the page inverting signal and outputs the inverted page to the printer driver 202.

The printer 21 includes a storage unit 211, a control unit 212, and a head unit 213. Here, the head unit 213 may be a line-array head as illustrated in FIG. 1. The head unit 213 may have a length that is substantially equal to or greater than a width of the page to be printed.

The storage unit 211 temporarily stores the PDL data output from the printer driver 202. The control unit 212 may decode the PDL data stored in the storage unit 211 into the JPEG format and the JBIG format, respectively, to decompress the PDL data and perform color correction, gamma correction, and horizontal enlargement to the JPEG data. The control unit 212 may then synthesize the JPEG data with the JBIG data, may perform a halftone process to the synthesized data, and output the processed data. Although the PDL data may be processed and synthesized into JPEG format and JBIG format, it should be understood that additional and/or other processing operations/formats may alternatively be used with the present general inventive concept. The control unit 212 then counts a number of pages to be printed, and when the number of pages is greater than a threshold value “n,” the control unit 212 outputs the page inverting signal to invert the page to the signal receiving unit 203. In other words, when the number of pages printed during a current print job is greater than the threshold value “n,” the control unit 212 inverts one or more pages of a next print job as illustrated in FIG. 3, thereby uniformly using all of the nozzles in the head unit 213, instead of using the nozzles on the left more than the nozzles on the right, or vice versa. More generally, the control unit 212 may monitor an amount of printing that is performed (e.g., by using a number of dots or a number of pages printed) in order to perform the amount of printing in the normal mode that may be roughly equal to the amount of printing performed in the inverted mode. Alternatively, the amount of printing performed in the inverted mode may be less than the amount of printing performed in the normal mode.

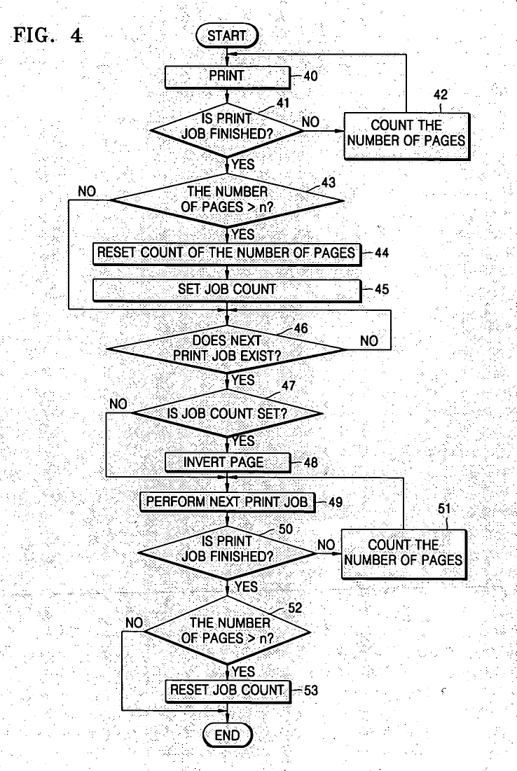

FIG. 4 is a flowchart illustrating a print method according to an embodiment of the present general inventive concept, which can increase a lifetime of a printer head, the head unit 213, and the printer 21. The method of FIG. 4 may be performed by the system of FIG. 2. Accordingly, the method of FIG. 4 is described below with reference to FIG. 2.

The control unit 212 performs a print job in accordance with a user's instruction (operation 40). The control unit 212 counts the number of printed pages (operation 42) while performing the print job (operation 41). Although the present embodiment describes that the number of pages is counted, it should be understood that the number of dots may alternatively be counted.

When the current print job is finished and the number of printed pages is greater than “n” (operation 43), the page number count is reset (operation 44). A job count is set to indicate whether the page is inverted (operation 45) and it is determined whether a next print job exists (operation 46). In other words, the job count may be a variable that is set and reset to indicate whether the control unit 212 controls the signal receiving unit 203 to output the page inverting signal. For example, if the job count is “1,” the control unit 212 may control the host 20 to provide a next page to be printed in the inverted mode, and if the job count is “0,” the control unit 212 may control the host 20 to provide the next page to be printed in the normal mode. When there is a next print job, it is determined whether the job count is set (operation 47) and when the job count is set, the page inverting signal is output to the signal receiving unit 203 (operation 48). The page inverting unit 204 reads out a page to be printed next from the storage unit 201 in accordance with the page inverting signal, inverts the read-out page as illustrated in FIG. 3, and outputs the inverted page to the printer driver 202. The printer driver 202 then converts the inverted page into the PDL data and outputs the PDL data to the storage unit 211 of the printer 21. The control unit 212 decodes the PDL data received from the storage unit 211 into JPEG and JBIG data and performs the next print job using the head unit 213 (operation 49). When the job count is not set in operation 47, the control unit 212 does not output the page inverting signal. Accordingly, the page inverting unit 204 outputs the page to be printed as is to the printer driver 202 without inverting the page to be printed in the normal mode. The printer driver 202 converts the received page into the PDL data and outputs the PDL data. The control unit 212 decodes the received PDL data into JPEG and JBIG data and performs the print job (operation 49). During the next print job (operation 50), the control unit 212 counts the number of pages (operation 51) printed during the next print job and determines whether the number of pages printed during the next print job is greater than “n” (operation 52) when the print job is finished. When the number of pages printed during the next print job is greater than “n,” the job count is reset so as to print a page to be printed next without inverting the page. When the number of pages printed during the next print job is not greater than “n,” the job count is not reset so that the printer 21 continues operation in the inverted mode and inverts a next page to be printed (operation 53). The control unit 212 uses the job count and the number of pages in order to determine whether pages of a print job are to be printed in the normal mode or the inverted mode. In this manner, all pages of the print job are printed in a single mode (i.e., either the inverted mode or the normal mode), and a user is not required to sort pages printed in two different modes. However, although the present embodiment describes that the pages printed in the normal mode and the inverted mode are determined according to the job count and the number of pages, it should be understood that the pages printed in the normal mode and the inverted mode may be determined according to the number of pages (or printed dots) and/or other information. For example, the control unit 212 may toggle between operation in the normal mode and the inverted mode whenever printer 21 is initialized.

The embodiments of the general inventive concept can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

According to the embodiments of the present general inventive concept, when using a line-array printer head, ejection rates of all nozzles in the line array printer head can be made uniform by inverting and outputting a page to be printed in accordance with a number of pages or a number of dots, thereby elongating an average lifetime of the printer head.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A print method, comprising:
counting an amount of printing performed in a current print job;
outputting a page inverting signal when the current print job is complete and the counted amount of printing performed is greater than a threshold value; and
receiving and printing a page of a next print job that corresponds to the page inverting signal.

2. The print method according to claim 1, wherein the counted amount of printing performed is one of a number of printed pages and a number of printed dots.

3. The print method according to claim 1, wherein the page of the next print job comprises a page obtained by inverting a page of the current print job.

4. The print method according to claim 1, wherein the printing of the page of the next print job comprises:
resetting the counted amount of printing performed and setting a job count indicating whether a page to be printed should be inverted upon completion of the print job when the counted amount of printing performed is determined to be greater than the threshold value;
checking whether the job count is set when the next print job exists;
outputting the page inverting signal when the job count is set and the next print job exists; and
receiving and printing the page that corresponds to the page inverting signal when the job count is set.

5. The print method according to claim 4, further comprising:
receiving and printing a page having the same direction as the printed page without outputting the page inverting signal when the job count is not set.

6. The print method according to claim 4, further comprising:
counting the amount of printing performed in the next print job; and
resetting the job count upon completion of the next print job when the counted amount of printing performed in the next print job is greater than the threshold value.

7. A method of printing, the method comprising:
printing a first one or more pages in a normal mode; and
printing a second one or more pages in an inverted mode.

8. The method according to claim 7, wherein:
the printing of the first one or more pages in the normal mode comprises performing a print job using a wide array type ink jet head in which print data on the first one or more pages is printed in a first direction; and
the printing of the second one or more pages in the inverted mode comprises performing a print job using the wide array type ink jet head in which print data on the second one or more pages is printed in a second direction opposite to the first direction.

9. The method according to claim 7, further comprising:
outputting the first one or more pages after printing to have a normal orientation; and
outputting the second one or more pages after printing to have an inverted orientation that is rotated 180 degrees with respect to the normal orientation.

10. A method of printing, the method comprising:
monitoring an amount of printing performed in one or more jobs of a print head having a plurality of nozzles; and
controlling the print head to print in one of an inverted mode and a normal mode such that the nozzles at two ends of the print head have about a uniform ejection rate according to the monitored amount of printing performed.

11. The method according to claim 10, wherein the monitoring of the amount of printing performed comprises:
counting a number of print units printed when the print head is controlled to print in a first mode of the normal mode and the inverted mode; and
comparing the number of print units printed with a predetermined threshold.

12. The method according to claim 11, wherein the number of print units comprises one or more of a number of pages printed and a number of dots printed.

13. The method according to claim 11, wherein the controlling of the print head to print in one of the inverted mode and the normal mode comprises:
controlling the print head to switch between the normal mode and the inverted mode to a second mode and resetting the counted number of print units when the number of print units is determined to be greater than the predetermined threshold.

14. The method according to claim 11, wherein the controlling of the print head to print in one of the inverted mode and the normal mode further comprises:
controlling the print head to switch between the normal mode and the inverted mode to a second mode when the number of print units is determined to be greater than the predetermined threshold and when a current print job is completed.

15. The method according to claim 10, wherein the controlling of the print head to print in one of an inverted mode and a normal mode comprises:
counting a number of print units printed when the print head is controlled to print in the one of the inverted mode and the normal mode;
comparing the number of print units printed with a predetermined threshold;
switching between the normal mode and the inverted mode when the number of print units is greater than the predetermined threshold by outputting a signal to a host to instruct the host to invert print data of a page to be printed or not invert the print data of the page to be printed according to the comparison of the number of print units and the predetermined threshold;
receiving one of the inverted print data and the print data of the page to be printed; and
controlling the print head to print the received print data.

16. The method according to claim 10, further comprising:
receiving one of inverted print data and normal print data in a page description language (PDL); and
decoding the PDL data; and
processing the PDL data,
wherein the controlling the print head to print in one of the inverted mode and the normal mode comprises controlling the print head to print the processed PDL data that corresponds to the one of the inverted print data and the normal print data.

17. A method of printing, the method comprising:
inverting print data of one or more pages to be printed when a page inverting signal is received from a printer; and
providing the inverted print data of the one or more pages to the printer when the page inverting signal is received therefrom.

18. The method according to claim 17, further comprising:
receiving the page inverting signal from the printer when the printer determines that the one or more pages should be inverted so that a plurality of nozzles in a nozzle unit of the printer are uniformly used.

19. The method according to claim 17, wherein the inverting of the print data comprises rotating the print data 180 degrees with respect to a normal orientation.

20. The method according to claim 19, wherein the inverting of the data further comprises converting the inverted print data into page description language (PDL).

21. A printer to receive a page from a host and to print the received page, the printer comprising:
a control unit to count an amount of printing performed in a print job, to output a predetermined signal to the host when the counted amount of printing performed in the print job is greater than a threshold value, and to process and output a page received from the host in response to the predetermined signal; and
a head unit to print the page output from the control unit.

22. The printer according to claim 21, wherein the page received from the host in response to the predetermined signal comprises a page having an inverted direction.

23. A printer, comprising:
a print head; and
a control unit to control the print head to print a first one or more pages in a normal mode and to print a second one or more pages in an inverted mode.

24. The printer according to claim 23, wherein:
the print head comprises a wide array type ink jet head; and
the control unit controls the print head to perform a print job in which print data on the first one or more pages is printed in a first direction, and a print job in which print data on the second one or more pages is printed in a second direction that is opposite to the first direction.

25. The printer according to claim 23, wherein the print head outputs the first one or more pages after printing to have a normal orientation, and outputs the second one or more pages after printing to have an inverted orientation that is rotated 180 degrees with respect to the normal orientation.

26. A printer, comprising:
a print head having a plurality of nozzles to perform one or more jobs; and
a control unit to monitor an amount of printing performed in the one or more jobs and to control the print head to print in one of an inverted mode and a normal mode such that the nozzles at two ends of the print head have about a uniform ejection rate according to the monitored amount of printing performed.

27. The printer according to claim 26, wherein the control unit monitors the amount of printing performed by counting a number of print units printed when the print head is controlled to print in a first mode of the normal mode and the inverted mode, and compares the number of print units printed with a predetermined threshold.

28. The printer according to claim 27, wherein the number of print units comprises one or more of a number of pages printed and a number of dots printed.

29. The printer according to claim 27, wherein the control unit controls the print head to switch between the normal mode and the inverted mode to a second mode and resets the counted number of print units when the number of print units is determined to be greater than the predetermined threshold.

30. The printer according to claim 27, wherein the control unit controls the print head to switch between the normal mode and the inverted mode to a second mode when the number of print units is determined to be greater than the predetermined threshold and when a current print job is completed.

31. The printer according to claim 26, wherein the control unit counts a number of print units printed when the print head is controlled to print in one of the inverted mode and the normal mode, compares the number of print units printed with a predetermined threshold, switches between the normal mode and the inverted mode when the number of print units is greater than the predetermined threshold by outputting a signal to a host to instruct the host to invert print data of a page to be printed or not invert the print data of the page to be printed according to the comparison of the number of print units and the predetermined threshold, receives one of the inverted print data and the print data of the page to be printed, and controls the print head to print the received print data.

32. The printer according to claim 26, wherein the control unit further receives one of inverted print data and normal print data in a page description language (PDL), decodes the PDL data, processes the PDL data, and controls the print head to print the processed PDL data that corresponds to the one of the inverted print data and the normal print data.

33. A host to output a page to be printed by a printer, the host comprising:
a storage unit to store the page;
a signal receiving unit to receive a predetermined signal from the printer;
a page inverting unit to output the page stored in the storage unit as is or to invert and output the page based on whether the predetermined signal is received; and
a printer driver to convert the page output from the page inverting unit into data suitable for a print job of the printer and to output the converted page.

34. A host device, comprising:
a page inverting unit to invert print data of one or more pages to be printed when a page inverting signal is received from a printer; and
a printer driver to provide the inverted print data of the one or more pages to the printer when the page inverting signal is received therefrom.

35. The host device according to claim 34, further comprising:
receiving the page inverting signal from the printer when the printer determines that the one or more pages should be inverted so that a plurality of nozzles in a nozzle unit of the printer are uniformly used.

36. The host device according to claim 34, wherein the page inverting unit rotates the print data 180 degrees with respect to a normal orientation.

37. The host device according to claim 36, wherein the printer driver converts the inverted print data into page description language (PDL).

38. A print system, comprising:
a host to output a page to be printed, and to invert and output the page to be printed when a predetermined signal is received; and
a printer to count an amount of printing performed in a print job, to output the predetermined signal to the host when the counted amount of printing performed in the print job is greater than a threshold value upon completion of the print job, and to receive and print the page output from the host in response to the predetermined signal.

39. The print system according to claim 38, wherein the host comprises:
a storage unit to store the page;
a signal receiving unit to receive the predetermined signal from the printer;
a page inverting unit to output the page stored in the storage unit as is or to invert and output the page based on whether the predetermined signal is received; and
a printer driver to convert the page output from the page inverting unit into data suitable for the print job of the printer and to output the converted page to the printer.

40. A computer readable medium containing executable code to control a printer to operate in one or more of a normal page mode and an inverted page mode, the medium comprising:
executable code to determine an amount of printing that is performed during a first print job in a first mode of the normal page mode and the inverted page mode;
executable code to determine whether the amount of printing that is performed during the first print job exceeds a predetermined threshold;
executable code to switch between the normal page mode and the inverted page mode to a second mode and to control the printer to advance to a second print job or standby when the amount of printing that is performed during the first print job exceeds the threshold; and
executable code to control the printer to continue in the first mode and to advance to the second print job or standby when the amount of printing performed does not exceed the predetermined threshold.
